(19) United States
(12) Patent Application Publication
(10) Pub. No.: US 2010/0267403 A1
(43) Pub. Date: Oct. 21, 2010

(54) System, method and apparatus for facilitating content delivery

(75) Inventors: Pietro Lungaro, Stockholm (SE); Zary Segall, Baltimore, MD (US); Jens Zander, Upplands-Vasby (SE)

Correspondence Address: Raymond Van Dyke;Washington Square, P.O. Box 65302, 1050 Connecticut Avenue, NW, Washington, DC, 65302, US

(73) Assignee: Raymond Van Dyke, Washington, DC (US)

(21) Appl. No.: 12/662,516

(22) Filed: Apr. 21, 2010

Related U.S. Application Data
(60) Provisional application No. 61/171,326, filed on Apr. 21, 2009.

(51) Int. Cl. H04W 4/12

(52) U.S. Cl. 455/466

(57) ABSTRACT

A system, method and apparatus for facilitating content delivery in mobile access and other networks, and improving access to content and services in those networks. Mobile terminals and other user devices are increasingly used for content generation and content upload, in particular for what concerns photo and video types of content. Since the quality of the content generated with the aforementioned devices is dramatically increasing, the associated file sizes are also significantly larger. At the same time, the uplink of cellular and mobile systems has typically much less capacity than the downlink, thus solutions that can deliver improved performances in existing infrastructures, when uploading user created content, are highly beneficial for supporting user content generation in future devices and networks. The present invention increases the user experience and satisfies consumer expectations by proactively obtaining content deemed desired by a user and, through time and location shifting, preloads the material into a network-controlled portion of the user's mobile device.

### CROSS REFERENCE TO RELATED APPLICATIONS

The present invention claims priority from U.S. Provisional Patent Application Ser. No. 61/171,326, entitled “System, Method and Apparatuses for Facilitating Content Delivery,” filed Apr. 21, 2009, the subject matter of which is incorporated by reference herein.

### BACKGROUND OF THE INVENTION

1. Field of Invention

The present invention generally relates to systems, methods and apparatuses for facilitating content delivery in mobile access and other networks. More specifically, the present invention relates to systems, methods and apparatuses for providing improved access to content and services in mobile and other networks.

2. Description of the Related Art

Currently, users employ various devices, such as personal computers (PCs), Personal Digital Assistants (PDAs), smartphones, etc., with access to wide-area networks, e.g., the Internet and cellular networks, to access and share content from various online services. Using a hand-held device, a user may, through these avenues, access content and services, including, but not limited to, music and video downloads, photo sharing, and information access, e.g., news, weather, sports, financial content, etc., and download content therefrom freely or purchase same. Additionally, providers of content and services allow users to create personal profiles to indicate preferences regarding desired content and services, as well as from communities of users for the exchange of content and services.

Providing a superior user experience (referred to herein as Quality of Experience or QoE) is the key to success in mobile services, and a primary focus of the present invention. The recent massive success of smartphones or so-called “superphones,” such as Apple's iPhone and Google's Android based handsets, provide an ample illustration of the dramatically increased capability and functionality of modern phones. Despite the incredible advances in the end devices, however, the operators of mobile networks have stumbled into a capacity quagmire. The wireless data demand of a superphone is presently at least two orders of magnitude larger than a traditional simple phone. Further, allowing laptop and tablet (such as Apple's Ipad and upcoming similar devices) connectivity to the cellular network further complicates the operator capacity problems. Of course, increasing the data rate and/or the capacity in the infrastructure is one way to improve user experience. However, deploying more infrastructures takes time, requires large investments and may run into the physical limits of spectrum availability.

The current core architecture of wireless networks is largely agnostic with respect of the type of data transferred, network status and user behavior. The present invention is directed to the transformation of the agnostic core network into a network semantically aware of the user behavior, network status and the nature of the data transmitted. Further, for such core networks, there are significant opportunities to optimize the network capacity while reducing cost and increasing QoE.

For example, so-called “online stores” represent a current trend for the distribution of multimedia content and applications. Starting with Apple, all major hardware and software vendors, including Microsoft and Nokia, have been adopting (or are planning to adopt) Internet-based platforms for providing their users with added-value applications and content. At the same time, “pure” content providers have entered the content distribution market, subsidizing devices capable of accessing their Internet stores. Amazon, currently launching a book-reader also capable of Internet access (the Kindle 2), represents an example of this trend.

However, in all these currently-implemented infrastructures, the end device users or consumers have to perform search operations over typically large databases, and proactively start content downloads when they want to gain access to some of the wanted content. Since these infrastructures and their technical solutions are squarely implemented at the service level, without considering the potentially or actually limiting constraints of different underlying networks, e.g., cellular infrastructure, use for data delivery, the time spent for downloading large files, e.g., movies and applications, ends up being quite large. This constriction thus limits the amount of data that users can “consume,” and, in turn, reduces user service appreciation. In this respect, the indications obtained from Applicants' research in this field clearly point out that the methodology of the present invention can greatly improve user service experience in wireless settings, thereby increasing media consumption, and, in turn, increasing revenue streams for both operators and content providers. In one proposed embodiment of the present invention, having an “online shop” directly inside user terminals, fully loaded with content tailored to their users' individual interests, represents the next step in media delivery, and provides a significant competitive edge of the present invention over currently-implemented solutions and architectures.

Accordingly, there is a need for systems, methods and apparatuses for facilitating content delivery in mobile access and other networks. More specifically, there is a need for systems, methods and apparatuses for providing improved access to content and services in mobile and other networks employing semantic information or other data to better tailor the informational needs and desires of an end user proactively.

### SUMMARY OF THE INVENTION

The aforementioned needs are satisfied by several aspects of the present invention, directed to systems, apparatuses and methodologies for facilitating content delivery in mobile access and other networks, and improving access to content and services in those networks. Mobile terminals and other user devices are increasingly used for content generation and content upload, particularly photo and video content. Since the quality of the content generated with the aforementioned devices is dramatically increasing, the associated file sizes are also significantly larger. At the same time, the uplink of cellular and mobile systems has typically much less capacity than the downlink, necessitating solutions that can deliver improved performances in existing infrastructures, when uploading user created content, and also highly beneficial for supporting user content generation in future devices and networks. It should be appreciated that the embodiments herein can be implemented in numerous ways, including as a method, software, a circuit, a system or a device. Several embodiments of the present invention are described below.

In one embodiment, a method for remotely accessing protected content is provided. Here, a user on a remote device desires access to protected content on a memory card, such as on an internal handset memory. A trusted third party requests the necessary credentials stored on a home device, which are downloaded to the user at the remote device, where the protected content is then accessed.

In another embodiment, an internal handset memory or memory card containing protected content is provided. The card has credential means for protecting the content, and access means to unlock the content upon receipt of the necessary credentials.

In still another embodiment, a system for remotely storing and accessing protected content is provided. A user on a remote device desires access to protected content on a memory card. A trusted third party requests the necessary credentials stored on a home device, which are downloaded to the user at the remote device, where the protected content is accessed.

Other embodiments and advantages of the invention are apparent from the following Detailed Description, taken in conjunction with the accompanying Drawings, illustrating, by way of example, the principles of the invention.

### BRIEF DESCRIPTION OF THE DRAWINGS

The present invention will be readily understood by the following Detailed Description in conjunction with the accompanying Drawings, where like reference numerals designate like structural and other elements.

FIG. 1 is a schematic representation of components employed in the operation of a mobile networked system in accordance with an embodiment of the invention; and

FIG. 2 is a schematic representation of an end user device having partitioned memory, as shown in FIG. 1 and in accordance with an embodiment of the invention.

### DETAILED DESCRIPTION

In the following description of embodiments of the invention, reference is made to the accompanying Drawings that form a part hereof, and in which is shown, by way of illustration, a number of specific embodiments in which the invention can be practiced. It is to be understood that other embodiments can be utilized and structural changes can be made without departing from the scope of the present invention.

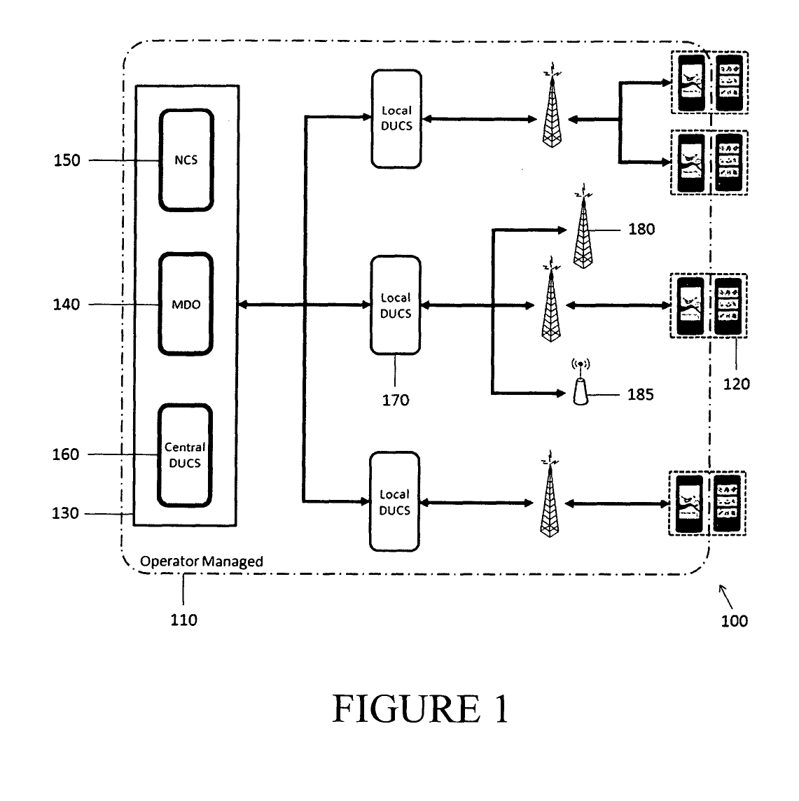

With reference now to FIG. 1 of the present invention, there is illustrated therein the overall architecture of an improved content delivery system, generally designated by the reference numeral 100, to facilitate the delivery of content to end users within the network system 100 pursuant to the teachings of the present invention. In this embodiment, the system 100 includes an operator-managed network, designated by the reference numeral 110, and the end users on their devices, generally designated by the reference numeral 120, which may include Enhanced Handsets (EH), described in more detail hereinbelow, in communication with the network infrastructure.

With reference again to FIG. 1, the operator-managed network 110 has an operator control portion, generally designated by the reference numeral 130, which contains a Media Delivery Optimizer (MDO) 140, a Network Context Server (NCS) 150, and a Central Download/Upload Cast Server (CDUC) 160. The operator control portion 130 communicates with a number of local Download/Upload Cast Servers (DUCS), generally designated by the reference numeral 170, which, in turn, e.g., acting as wireless local area networks (WLANS), communicate with base stations, generally designated by the reference numeral 180, and other access ports (APs), generally designated by the reference numeral 185.

The proposed invention, employing the infrastructure of FIG. 1 or equivalents thereto, is an improved information delivery method for mobile wireless access networks based on the emerging concept of “ActiveCast.” In other words, the invention employs a semantic wireless core network 100 that uses time and location shifted downloading into a plurality of user mobile handsets 120 of data objects and software applications that are predicted to be relevant in the future to the user, thereby creating a user experience of a very large selection of items readily available. Indeed, the ActiveCast model of increased scalability and customizability of active services creates a simple but powerful platform for applications, as well as enhances the user-friendliness of those applications to the consumer, goals of the present invention.

With reference again to FIG. 1, the present invention provides more efficient use of the wireless network 100, both in terms capacity and coverage, by employing the ActiveCast concept. Furthermore, by exploiting both single user and correlated groups of user information and network performance related information, such as mobility patterns, terminal capabilities and network load (both predicted and actual), a network operator of the network 110 can effectively anticipate the delivery of some future user-requested content and applications to the EHs 120 at time instants and locations (access ports) that optimize both the users' and the network's performances. Another feature of the present invention is the network operator opportunity to move from single user delivery of data objects (unicast) to multiple user simultaneous delivery of data objects (multicast).

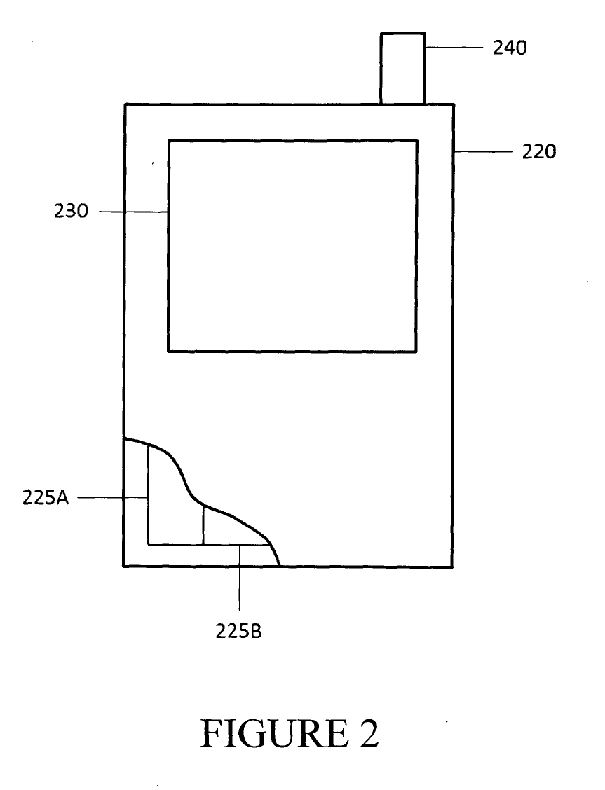

With reference now to FIG. 2 of the Drawings, there is shown therein an exemplary end user device, such as an EH 120, which may be employed pursuant to the teachings of the instant invention. The end user terminal device, generally designated by the reference numeral 220, has a screen 230 for displaying the downloaded information, antennae 240, along with the requisite telecommunications circuitry and software for connectivity, and includes a partitioned memory therein. To perform content delivery operations in a transparent and predictive manner, the methodology of the present invention requires that part of the individual terminal memory in the EHs 220 is controlled by the network operator, which directly operates on this partition, generally designated by the reference identifier 225A. Indeed, memory portion 225A is like a distributed extension of available network memory resources, delivering and storing therein content likely to be of interest to each specific end-user. In short, the “ActiveCast” paradigm combines the rich user experience of “on-line”, on-demand systems, with the resource efficiency of “data-push” systems.

It should, of course, be understood that access to the downloaded content stored in the operator-controlled partition of the memory 225A is regulated (e.g., employing encryption) by the network operator, who can, in this way, learn over time individual user behavior and interests, as well as make sure that fees are collected for any intellectual property protected content used by the user. Through an improved user interface and other aspects of the present invention, that simplify information search and access to content, end users can receive, in return, much faster access to data objects and applications that are predicted to be of relevance to them. This translates to an improved perception and experience of the coverage and capacity available in the network, for the content of which users are consciously interested in, but also to receive instantaneous access to a significant amount of novel information that is most likely of interest for the users, but of which they were previously unaware.

Further, the present invention includes the capability to collect and process both single user and correlated user groups information, and transform that data in predicted future consumption of data objects and applications. Moreover, in order to infer relevant information about user preferences, mechanisms like content recommendations from other users, or explicit user declarations of preferred content categories are also possible.

A preferred embodiment of the proposed invention includes an apparatus and associated software that includes:
a plurality of hardware and software enhanced handsets 120/220,
a predictive user context (location and time, but not limited to) shifting file,
casting embodiment in hardware and software, and
a wireless network capacity and coverage optimization embodiment in hardware and software, such as illustrated in FIG. 1.

The present invention includes a variety of applications of the above technologies preferably in mobile services, in enhanced handsets, such as the EHs 120/220, and in the associated user experience. In one preferred embodiment, the present invention includes the novel concept of using the aforementioned Enhanced Handsets (EH) with the download/upload active cast servers (DUCS) to otherwise enhance the overall user experience, creating a synergistic, anticipatory and rewarding user experience much greater than the constituent component parts.

With reference again to FIG. 2 of the Drawings, there is illustrated therein the organization of the EH 220 in a preferred embodiment of the instant invention, which includes the memory 225 divided in two partitions, generally designated by the reference identifiers 225A and 225B. The first partition 225A, remotely controlled, is shared (SP) with an operator or a content-provider located DUCS, such as the aforementioned CDUCS 160, which is completely under operator or content provider control. This bifurcation concept is further illustrated in FIG. 1, where a portion of the EH 120 is within the purview or control of the network operator, i.e., that portion of the EH 120 within the network 110 and under direct operator control, i.e., the memory partition 225A in FIG. 2. A plurality of hardware and software in the EH 220 supports this functionality, which may include, but is not limited to, cryptography and Operating System extensions. The second memory partition 225B, shown outside of network operator control in FIG. 1 in the bifurcated EH 120, is under user control (UP) in the normal fashion. It should be understood that the SP 225A is mainly serving as a data objects and applications active casting storage area.

The benefits of the present invention, reflected in the architecture shown in FIGS. 1 and 2, are manifest. With consumers demanding increasingly more access, connectivity and flexibility, the system, method and apparatuses of the present invention provide a significant advance over the traditional systems of today and anticipate the consumer needs of tomorrow. Some preferred aspects of the present invention are described in more detail hereinbelow.

User Experience and Associated Interface (UI):

Users, such as those employing the enhanced handsets 220 of the present invention, may want to access a data object or get an offer to access a data object. With some high probability due to their patterns of usage, discerned by the principles of the present invention, that data object has been identified and uploaded, and is already in the SP 225A, creating the opportunity of immediate access to a very wide selection of items without download delay. Hence, the user experience is “immediate gratification” and the (video/music) data object is delivered/played directly from the SP 225A. Further, this same user experience is available in areas of no coverage (e.g., airplanes) or with limited coverage (e.g., remote areas), with the pre-fetching being handled earlier while connectivity was good. It should be understood that to benefit from this particular service the user may need to opt in for this capability. The service, however, could be financially supported by a plurality of combinations of subscription, pay-per-use and advertising.

Active Casting Based on Predictive User Context Shifting (PUCS):

User context in the present invention is defined as the plurality of user-related information required to determine the user situation, particularly with regard to the usage of a particular mobile service. Predictive user context is defined as the plurality of user contexts that could be used to infer the future user's need for a particular mobile service. The concept of predictive context shifting has been used in network resource allocation, and is used in the instant invention in order to effectuate the user experience described above. The implementation of the present invention may be in hardware and/or software (located in network and or EH), as is understood in the art. Functionally, the predictive context shifting manifests as a time and location shifted file casting. The Downloading Upload Context Servers—the DUCS 170 located in the core network 110, but potentially also partially distributed in the EH, such as in the memory or SP 225A—collect and employ profiling user requests and mobility patterns over time. These devices/algorithms keep track of their current status, handset SP content, location and any other pertinent information that defines the user context. Over time, user patterns and expected results are gleaned from the sampling of the user activities done on their own phone.

Network Capacity and Coverage Optimizer—Media Delivery Optimizer:

The Media Delivery Optimizer (MDO) 140 of the present invention includes an apparatus, with associated software, capable of matching the aforementioned user context information (current and predicted) provided by an interface, such as the CDUCS 160, with the DUCS 170, with the network context (current and predicted) obtained through an interface with the Network Context Server (NCS) 150. NCS 150 performs the task of monitoring the current availability of resources in the different sub-nets and their distribution backbones, and is equipped with software solutions that allow the prediction (estimation) of future resource availability in the same subnets. In a preferred embodiment of the present invention, a single operator, who is also controlling the MDO 140, manages the different subnets. However, the ActiveCast principles of the present invention also allow alternative implementations, such as content delivery through independent networks managed by multiple operators. In this embodiment, the MDOs, most likely managed by content providers, are interfaced to the NCSs representing the different networks.

In all cases, the main task of the MDO 140 is to perform spatio-temporal decisions on when, and at which sub-net and port, delivering information to individual EHs 220 (per a time-space content delivery schedule). These decisions are based on the optimization of some performance metrics (e.g., value functions), including (but not limited to) the minimization of the total amount of resources invested in the delivery of a set of scheduled media items to a number of EHs 220 (in preferred embodiment) or the total delivery cost (more likely in the multi-operator embodiment).

Similar optimization procedures are performed when using, the ActiveCast principles of the present invention for uploading information, either from EHs to EHs or from EHs to some remote content servers. In those settings user generated content can be moved by the user controlled terminal partition to the operator controlled one. This allows the operator to optimize the location and time associated with the upload of user generated content to a remote server. Among other metrics, mobile operators can also target the reduction of the terminal energy costs needed for completing the content upload.

It should be understood that there are various ways to optimize the time and location metrics of the overall network 100. For example, in order to exploit multiplexing gains that are achievable when transferring information through the backbones of the different sub networks, the MDO 140 can also decide to temporarily store information in some caching facilities, each one equipped with his own local DUCS 170, and thus resulting in an architecture presenting a “cascade” of DUCS servers 170, as shown in FIG. 1. Information may also be cached in the base stations 180 and intermediate access ports 185. These caching facilities are typically the ones covering access ports where multiple EHs 220, interested (even if with different values) in the same information, are predicted to be connected to in the near future. Moreover, depending on the number EHs 220, which are both interested in receiving the same data items and simultaneously co-located within an access port, the MDO 140 can also decide to perform a wireless multi-cast transmission, if supported by the protocol in place at the aforementioned access port.

Whenever the actual user and network context information, feed by the DUCS 170 and the NCS 150, present significant differences from the previously predicted one, the MDO 140 re-computes a spatial-temporal distribution schedule. This schedule is adopted only if its performances, computed based on the aforementioned optimization metrics, are expected to improve the metrics of the old schedule performing under the current user and network contexts.

Traditional solutions to providing a similar personal service involve the user at their handset requesting a data object, which initiates the downloading of information/services from central servers. This, however, is neither efficient nor practical from a network perspective since:
unicast transmission (for each handset) is used, ignoring the resource leverage within the system,
severe congestion can be experienced when popular content is simultaneously accessed during peak hours,
the user experience is not improved in areas of poor wireless broadband connectivity,
the quality and cost of broadband access may also be prohibitive during peak hours.

It should, of course, be understood that depending on which context information is available and on the size of the operator controlled memory partition 225A, different products and applications could be envisioned, embodiments of some of these applications are described hereinbelow.

Copyrighted content delivery: by encrypting the copyrighted content and storing the information files into the operator-controlled partition 225A of the EHs 220, network operators can play an important role in the content delivery value chain. Upon user requests, operators do not need to deliver the whole file (since the file itself was targeted for upload earlier), but only a digital key of a small number of bytes, a keyword that allows unlocking the protected content. In this way, operators can save capacity in times and locations where radio resources are scarcer and deliver instantaneous gratification to their users with an improved perception of coverage and capacity. Moreover, content providers can increase their revenue for the copyrighted protected material, reducing the effect of piracy and illegal distribution.

Supermarket Scenario: by having access to user context information concerning the shopping habits of users, for example by interfacing, the ActiveCast principles of the present invention to the “loyalty cards” servers commonly used in the majority of supermarket, shopping malls or individual supermarket can push promotions and products' coupons directly into user terminals 220. This information delivery could be done when the radio resources are less utilized and thus cheaper (e.g., overnight). This advanced type of advertisement can be tailored to individual users, or can even address a more general public, for example, when promoting new products. In the latter cases, the information delivery can also be performed in a more efficient way, by additionally exploiting the multicasting capabilities associated with most of the future cellular technologies (e.g., multicasting or broadcasting in Multimedia Broadcast/Multicast Service (MBMS), Digital Video Broadcast-Handheld (DVB-H) or other emerging technologies).

Corporate terminals backup and sync: business organizations always look for solutions that keeps the devices of their employees up to date and synchronized. In this respect, the ActiveCast principles of the present invention can be employed in an effective and cost-efficient solution for delivering software applications to the terminals, for keeping track of licenses, for updating the company phone book and storing presentations and other corporate material in the terminals. Indeed, the present invention can be used for all types of information that vary on a medium/slow time scale (on the order of a day), thus performing synchronization and content delivery overnight, as well as backing up on the company servers sensitive content stored in individual terminals, all can be easily performed.

Reducing the digital divide: a significant part of the developing world population has difficulty in reading or writing. With the prediction capabilities of the instant invention, specific data objects and applications could be delivered with little or no direct user interaction.

Conceptually, the ActiveCast principles of the present invention constitute a generic platform, enabling a variety of improvements proposed herein. A number of factors make the present invention attractive, such as those to the following actors:
1. Mobile customers are attracted to mobile services that offer a superior user experience and value.
2. Mobile operators are looking for new sources of revenues that will amplify the return on investment, and provide new ways to optimize the network for better capacity and coverage.
3. Infrastructure manufacturers are interested in new products that will satisfy factors (1) and (2).
4. Handset manufactures are concerned with offering new mobile phones with extended hardware and executive functions that will satisfy factors (1) and (2).
5. Content owners are interested in increasing the revenue derived from distribution of content, while reducing piracy.

The ActiveCast principles of the present invention address all the above actors' motivations, by providing technological innovation, as well as a number of attractive business models that are likely to generate new revenues, while simultaneously optimizing the wireless network capacity and coverage.

The following aspects are presently preferred embodiments of our proposed information delivery method.

EH-DUCS: having part 225A of a user terminal 220 memory in complete control of an operator is one of the key features of the instant invention. This, in combination with a context server that decides on downlink information deliveries, when network conditions and costs allows it, represents a significant paradigm shift for regarding content distribution. Moreover, the instant solution is also suitable for uplink delivery of user-created content (e.g., photos and videos) and their distribution. Apart from giving the user the feeling of much higher data rates than typically available with “on demand” type of content delivery, the ActiveCast principles of the present invention allow service provision beyond the coverage of the network, made possible because the information is directly stored in the operator-controlled partition 225A of terminals 220. The embodiment of the EH may be in the form, but not limited to a software agent, an application running in the terminal and or a software server running in the terminal.

Context Shifting: while time shifting has already been exploited in some successful commercial products (e.g., TiVo), context shifting is an area of endeavor still unexplored. The possibility of exploiting information concerning user location, terminal energy and memory, access cost, current and predicted mobility and traffic estimates allows for a much richer and performing allocation of resources at the network side, thus reducing costs and potentially improving network utilization.

Rights Management: The ActiveCast principles of the present invention with the proposed delivery method inherently makes it possible to track the consumption of copyrighted material, and therefore to provide compensation to content providers. The proposed solution is based upon, but is not limited to, the adoption of encryption for those multimedia files and applications that require an economic transaction before access.

User Experience: two novel features are provided by the ActiveCast principles of the present invention to improve user experience. On one hand, the user interaction model simplifies the search for relevant information and reduces the amount of time needed for retrieving it, while on the other hand, it allows also to receive suggestions and explore content that is new, potentially interesting, for the end users. The combinations of both these features deliver unprecedented user experience.

Simulations have been performed and indicated substantially wireless network efficiency gains and improved user perceived quality for a number of realistic network operation regimes.

It should, of course, be understood that the aforementioned description is exemplary of the embodiments of the present invention. In order to accomplish the pre-fetching of data and information desired by users, algorithms are employed to divine what future data objects that that user (as well as others related) will desire, and any other data objects that may strike the user's fancy and intrigue them. The following description of proposed pre-fetching techniques is intended to be illustrative of an embodiment of the principles of the present invention.

Technical Description of Preferred Pre-Fetching Algorithms

The software architecture of the ActiveCast principles of the present invention include software agents that are working in the handsets and in the core network. Their functionality includes, but is not limited to:
Monitoring in the handset: user requests for data objects, user consumption of data objects, the persistence of user objects, the nature of data objects, power available, power usage patterns, spectrum availability, location, user location patterns
Pushing data objects in the EH memory
Resource managers and scheduling agents in DUCS and EH
Prediction agents in DUCS
Distributed caching software agents in DUCS and EH

Context Aware Software Agents

Supporting pre-fetching data objects, there are a number of context-aware software scheduler embodiments, constituting a significant part of the proposed innovation. Details of these embodiments are set forth hereinbelow.

Context-Aware Schedulers

In this embodiment, referred to herein as “Over-The-Top” (OTT), pre-fetching operations are completely transparent to the network operator, who cannot therefore discriminate between users' and agents' requested traffic. Two novel OTT schemes are considered for this embodiment of the proposed scheduling innovation:
p-persistent OTT (PP-OTT): in this scheme, an idle terminal enters in the pre-fetching mode with a probability pₚᵣₑ in each time slot of duration Tₛ seconds. After that, every Wₜ slots the terminal agent evaluates the average downlink rate R̅_̅{̅d̅}̅(Δₜ) achieved during the previous Δₜ=Wₜ·Tₛ seconds, and compares it with a reference target rate [symbol] The terminal remains in the pre-fetching mode until the moment when R̅_̅{̅d̅}̅(Δₜ)≧ [symbol] (Δₜ). Instead, as soon as R̅_̅{̅d̅}̅(Δₜ)< [symbol] (Δₜ) the terminal goes back to the sleep mode and starts again the probabilistic wake-up process from the beginning, with the same wake probability pₚᵣₑ.
p-adaptive OTT (PA-OTT): this approach is similar to the p-persistent P-OTT, with the main difference being that the probability pₚᵣₑ is not fixed a priori, and it varies in time according to the different network and load conditions encountered. This approach is also governed by the following formulas:

$${p}_{pre} [ ( n + 1 ) {Δ}_{t} ] = \{ \begin{matrix}min \{ {c}_{up} \cdot {p}_{pre} ( n {Δ}_{t} ) , 1 \} & if \overline{{R}_{d} ( n {Δ}_{t} )} \geq \\ {c}_{dn} \cdot {p}_{pre} ( n {Δ}_{t} ) & if \overline{{R}_{d} ( n {Δ}_{t} )} <\end{matrix}$$

where cᵤₚ, and c_{dn} represent the coefficients of the adaptation and pₚᵣₑ (0) is set equal to the inverse of the number of users associated with the same BS 180 (or sector). Different terminals might end up having different values pₚᵣₑ, for mainly depending on the loads of the cells or areas they visited and on the channel quality experienced in time.

Context-Aware Schedulers

Since in this embodiment the operator is not aware of the probability pⱼⁱ, with which user j will request and consume item i, all requests are treated equally, with no distinction between pre-fetching traffic (associated with pⱼⁱ<1) and user-initiated sessions (with pⱼⁱ=1). Note that any item, which is originally requested with an a priori probability pⱼⁱ, changes its probability value to pⱼⁱ=1 after being explicitly requested by user j.

Instead, in a preferred embodiment of the present invention, in which the pre-fetching operations are coordinated by the network operator a set of novel schemes are proposed:

Software Pre-Fetching Schemes:
BS Polling (BSP): in this scheme, the transition between sleeping and pre-fetching mode can only be triggered by an explicit “poll” message sent by the BSs 180. This message is sent by the operator whenever a BS has an excess of resources (e.g., available power for downlink transmission in High Speed Downlink Packet Access or HSDPA) at any given point in time. The reception of this message triggers the “wake up” of the sleeping terminals. The associated terminal agents respond by communicating, on the uplink, the pⱼⁱs associated with the item they want to be served with. Once all reports are received, the operator selects to serve terminals based on the effective rate associated with their request. This is computed at time t as R_{eff}(i,j,t)=pⱼⁱ·Rⱼ(t), where Rⱼ(t) is the instantaneous rate achievable on the downlink for serving user j.
BS Polling with Random Wakeup (BSP-RW): this is an approach that merges BSP with PA-OTT. Similar to BSP, the terminals enters in pre-fetch mode when triggered by a polling message sent from the BS 180. However, even when located in coverage of BSs with other terminals on mode terminals could try to pre-fetch data, with a wake up probability pₚᵣₑ which is updated in the same way as in PA-OTT. In this respect, the main difference is that the resource allocation performed by the operator is based on the effective rate, thus takes into account the consumption probability associated with each specific item requested by the different users. In this case a pre-fetching terminal 1, requesting a given item a, is served instead of an active terminal q only if pₗ^{a}·Rₗ(t)>R_{q}(t).
BS Polling with Energy Aware Random Wakeup (BSP-EARW): this scheme is similar to BSP-RW, but in addition it includes a variation of the target data rate \hat{R} in function of the item probability pⱼⁱ. For items with lower probability an higher target rate is requested, so that lower overall energy is invested in the pre-fetching of content less likely to be accessed. Different expressions for \hat{R} in function of pⱼⁱ can be proposed for achieving a pre-defined energy costs associated to pre-fetching operations.

It should be understood that all the aforementioned techniques or schemes are designed to regulate the access to resources when pre-fetching data. At the same time, these could be complemented by a caching policy, for pre-storing “popular” content in designated caching facilities intermediate to the end users. In the instant proposed model, the network operator has access information concerning the aggregated user content demand. Whenever a BS 180 experiences some excess capacity in its backhaul, this could be used for storing in the BS 180 cache data items likely to be requested in the near future (e.g., the most popular ones). At the same time, content served to either pre-fetching or active users can also be stored in the cache for future re-utilization.

Backhaul Limitations and Resource Assignment

Each BS (node B) k is connected to an NRC through a backhaul of capacity R_{back}^{k} Mbps. The backhaul plays an important role, since in some configurations it might drastically limit the capacity of the communications, acting as bottleneck for the achievable downlink data rate. In general, the end rate perceived by the user can be computed as rₖⱼ=min{Rₖⱼ,R_{back}^{kj}} where R_{back}^{kj} represents the share of total backbone capacity at BS k (R_{back}^{k}) assigned for serving the requests of user j. Given a set of users Nᵤ^{k}, all simultaneously served by BS k, three different backhaul resource management schemes have been considered:
Equal share (EB): the total backhaul capacity is identically shared among all users requests with shares R_{back}^{kj}=(1/Nᵤ^{k)·R}_{back}^{k}, ∀jεNᵤ^{k}.
Shares proportional to C/I (CB): the shares of backhaul depend on the link quality experienced in the individual wireless link. This means that individual with a better channel will also receive more bits at the BS. The backbone shares assigned to user j are computed

$${R}_{back}^{kj} = ( {Y}_{kj} / {\sum }_{m = 1}^{{N}_{u}^{k}} {Y}_{km} ) \cdot {R}_{back}^{k} , ∀ j ∈ {N}_{u}^{k} .$$

Shares proportional to the expected number of consumed bits (BB): since part of the traffic served by BSs is constituted by content pre-fetching, not all bits are equally likely to be actually “consumed” by the end users. For the schedulers in which the network operator has access to detailed pre-fetching information (i.e., not OTT schemes), a service differentiation in the backhaul can be performed. In those cases the achievable data rate can be modulated by the probability of consumption of the item itself. The backhaul shares associated with the different users are then computed as

$${R}_{back}^{kj} = [ ( {p}_{j}^{i} \cdot {R}_{kj} ) / {\sum }_{m = 1}^{{N}_{u}^{k}} ( {p}_{m}^{i} \cdot {R}_{km} ) ] \cdot {R}_{back}^{k} , ∀ j ∈ {N}_{u}^{k} .$$

Note that in this equation and where pₘⁱ is the probability of consumption of the item currently requested (i) by a terminal m co-located within coverage of the same BS k. If the terminal is in active mode then also in this case pₘⁱ=1.

Caching Policies

In all cases in which BSs are dimensioned so that R_{back}^{k}≧ [symbol] the backbone does not represent a bottleneck to the communication. However, in many practical settings this is not the case. In order to improve performances when R_{back}^{k}< [symbol] the adoption of caches at the BSs is also considered. Whenever a user terminal requests a given item, a copy of the delivered file is stored in a memory location available at the BS. Once the item is placed in a cache, all consequent accesses to the item, from the same location do not require additional accesses to the backhaul, unless the validity of the item is expired or the item has been replaced according to one of the various cache replacement schemes described in previous literature. In this way, both larger shares of R_{back}^{k} are available for serving other users in the cell, and the users requesting cached content can be served with the maximum achievable rates on their wireless links. Different novel means to populate the caches with content can be adopted:
Reactive content storage (RC): content is stored in caching facilities only when requested by users connected to the cells controlled by the facility.
Proactive population-based content storage (PC): similarly to the “reactive content storage” scheme, the content directly requested by users is kept in the local memory. However, whenever there are shares of the backhaul capacity which are not allocated in a given time slot, those are used for retrieving and locally storing in the cache popular content. This can happen when a BS does not have connected users, or if all connected users are requesting cached content. The decision on which specific item to cache is taken considering the overall population access probability on the available item set ($p_{pop}$). Starting from the most popular objects the operator scans the caches in decreasing popularity value until the first missing item is found.
Proactive location-based content storage (LC): this scheme is similar to the aforementioned “proactive population-based content storage” except for the caching decisions performed during the periods of excess backhaul capacity. In this case, it is selected the most likely object to be requested by the closest terminals located in the closest six neighboring cells. In case no terminal is located in the closest tier of cells or if the object requested by the candidate terminal is already completely available in the cache, this scheme allocates all available resources for caching “popular” objects similarly to the previous scheme.

In some embodiments of the present invention, the devices perform specific operations by processor when executing one or more sequences of one or more program instructions stored in system memory. Such program instructions may be read into system memory from another computer readable medium, such as a storage device. In some embodiments, hard-wired circuitry may be used in place of or in combination with software program instructions to implement embodiments of the invention.

It should be appreciated that the term “computer readable medium” refers to a suitable medium that participates in providing program instructions to a processor for execution. Such a medium may take many forms, including but not limited to, non-volatile media, volatile media, and transmission media. Non-volatile media may include, for example, optical or magnetic disks, such as used in storage devices. Volatile media may include dynamic memory, such as used in system memory. Transmission media include coaxial cables, copper wire, and fiber optics, including wires that are used in a bus. Transmission media can also take the form of acoustic or light waves, such as those generated during radio wave and infrared data communications. Common forms of computer readable media include, for example, magnetic mediums (e.g., floppy disk, flexible disk, hard disk, magnetic tape, and other magnetic mediums), optical mediums (e.g., compact disc read-only memory (CD-ROM) and other optical mediums), physical medium with patterns (e.g., punch cards, paper tape, any other physical mediums), memory chips or cartridges, carrier waves, (e.g., RAM, programmable read-only memory (PROM), erasable programmable read-only memory (EPROM), flash memory, and other memory chips or cartridges), and any other medium from which a computer can read.

Memory devices employed in practicing the principles of the present invention include a variety of volatile and non-volatile memory structures and technologies. Examples of memory technologies include flash memories (e.g., NAND, NOR, Single-Level Cell (SLC/BIN), Multi-Level Cell (MLC), Divided bit-line NOR (DINOR), AND, high capacitive coupling ratio (HiCR), asymmetrical contactless transistor (ACT), and other flash memories), erasable programmable read-only memory (EPROM), electrically-erasable programmable read-only memory (EEPROM), read-only memory (ROM), one-time programmable memory (OTP), and other memory technologies. In an embodiment, the memory device may be a smart card using EEPROM, ROM, or other memory technologies. Examples of smart cards include a contactless smart card, a Subscriber Identity Module (SIM) card, and other smart cards. In another embodiment, the memory device can be a flash memory card using flash memory. Examples of flash memory cards include a variety of the following trademarked products such as Secure Digital™ (compliant with specifications maintained by the SD Card Association of San Ramon, Calif.), MultiMediaCard™ (compliant with specifications maintained by the MultiMediaCard Association (“MMCA”) of Palo Alto, Calif.), MiniSD™ (as manufactured by SanDisk, Inc.), MicroSD™ (as manufactured by SanDisk, Inc.), CompactFlash™ (compliant with specifications maintained by the CompactFlash Association (“CFA”) of Palo Alto, Calif.), SmartMedia™ (compliant with specifications maintained by the Solid State Floppy Disk Card (“SSFDC”) Forum of Yokohama, Japan), xD-Picture Card™ (compliant with specifications maintained by the xD-Picture Card Licensing Office of Tokyo, Japan), Memory Stick™ (compliant with specifications maintained by the Solid State Floppy Disk Card (“SSFDC”) Forum of Yokohama, Japan), TransFlash™ (as manufactured by SanDisk, Inc.), and other flash memory cards. In an embodiment, the memory device can be implemented as a non-removable memory device.

FIGS. 1 and 2 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps). Unless explicitly stated otherwise herein, the ordering or arrangement of the steps and/or components should not be limited to the descriptions and/or illustrations hereof.

In software implementations, computer software (e.g., programs or other instructions) and/or data is stored on a machine readable medium as part of a computer program product, and is loaded into a computer system or other device or machine via a removable storage drive, hard drive, or communications interface. Computer software can be implemented by any programming or scripting languages, such as Java, Javascript, Action Script or the like. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, or the like); or the like.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration. While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A telecommunications network comprising:
a media delivery optimizer;
at least one download/upload cast server in communication with said media delivery optimizer; and
at least one mobile device in communication with said at least one download/upload cast server,
said at least one mobile device comprising a memory, said memory comprising a network portion and a user portion,
wherein said media delivery optimizer preloads at least one data object into said network portion of said at least one mobile device, and
wherein said network portion contains therein said preloaded at least one data object forwarded to said at least one mobile device by a network operator in said telecommunications network, said at least one data object not downloaded by a user of said least one mobile device.

2. The telecommunications network according to claim 1, wherein said media delivery optimizer preloads at least one data object into said network portion of said at least one mobile device pursuant to a prediction means, said prediction means analyzing a plurality of contextual information concerning said telecommunications network and at least one user of said at least one mobile device.

3. The telecommunications network according to claim 1, wherein said at least one data object is first loaded onto said at least one download/upload cast server, and then uploaded to said at least one mobile device therefrom.

4. The telecommunications network according to claim 1, wherein said at least one data object is first loaded onto an intermediate device within said telecommunications network, and then uploaded to said at least one mobile device therefrom.

5. The telecommunications network according to claim 1, wherein said at least one data object is unicasted to one of said at least one mobile device.

6. The telecommunications network according to claim 1, wherein said at least one data object is multi-casted to a plurality of said mobile devices.

7. The telecommunications network according to claim 6, wherein multi-casting to said plurality of mobile devices is simultaneous.

8. The telecommunications network according to claim 1, wherein said at least one data object uploaded to said at least one mobile device is protected content.

9. The telecommunications network according to claim 8, wherein said protected content is accessible by a user.

10. The telecommunications network according to claim 1, wherein said at least data object comprises advertisements for perusal by users of said at least one mobile device.

11. The telecommunications network according to claim 1, wherein said network portion of the memory of said at least one mobile device comprises both said at least one data object and at least one network application, said network application facilitating the usage of said at least one data object on said at least one mobile device.

12. The telecommunications network according to claim 11, wherein said at least one network application is selected from the group consisting of a cryptography application and an operating system application.

13. The telecommunications network according to claim 1, wherein said media delivery optimizer preloads said at least one data object into said network portion of said at least one mobile device if said at least one mobile device is covered by a subscription.

14. The telecommunications network according to claim 1, further comprising:
a software agent, said software agent managing an operation, said operation selected from the group consisting of scheduling transference of said at least one data object, and caching said at least one data object.

15. The telecommunications network according to claim 14, wherein said software agent is resident in a memory, said memory selected from the group consisting of a memory in said at least one download/upload cast server and said network portion of memory within said at least one mobile device.

16. A mobile device in a telecommunications network comprising:
a display, said display for displaying data objects thereon for a user; and
a memory, said memory comprising a network portion and a user portion,
wherein said network portion contains therein pre-fetched data objects forwarded to said mobile device by a network operator in said telecommunications network, said data objects not downloaded by the user.

17. The mobile device according to claim 11, wherein said pre-fetched data objects are downloaded to said network portion of said memory in advance of a request by said user for said pre-fetched data objects, and
wherein said pre-fetched data objects are selected by at least one prediction means in said telecommunications network.

18. The mobile device according to claim 17, wherein said prediction means analyzes a plurality of performance data, and
wherein said performance data comprises at least one of data selected from the group consisting of user profiles, user requests, user predicted requests, group profiles, group requests, group predicted requests, user mobility patterns, predicted user mobility patterns, group mobility patterns, predicted group mobility patterns, mobile device connectivity and location, current network resource allocation, and predicted network resource allocation.

19. The mobile device according to claim 18, wherein said prediction means collects a plurality of data on user preferences.

20. A method for facilitating content delivery in a telecommunications system, comprising:
analyzing a plurality of performance metrics within said telecommunications system, said performance metrics including metrics on at least one mobile device user;
preloading at least one data object onto said at least one mobile device, said at least one data object being loaded into a network memory portion of said at least one mobile device before selection by said at least one mobile device user, said at least one data object not downloaded by said at least one mobile device user; and
selecting, by said at least one mobile device user, said at least one data object stored in the network memory portion of said at least one mobile device.
